(19) United States
(12) Patent Application Publication
(10) Pub. No.: US 2009/0211028 A1
(43) Pub. Date: Aug. 27, 2009

(54) Adjustable Bed Having Pocketed Coil Spring Assembly Layer

(75) Inventors: Darrell A. Richmond, Carthage, MO (US); William R. Rohr, Joplin, MO (US)

Correspondence Address: WOOD, HERRON & EVANS, LLP, 2700 CAREW TOWER, 441 VINE STREET, CINCINNATI, OH, 45202, US

(73) Assignee: L&P PROPERTY MANAGEMENT COMPANY, South Gate, CA (US)

(21) Appl. No.: 12/037,479

(22) Filed: Feb. 26, 2008

(51) Int. Cl. A61G 7/00; A47C 23/04

(52) U.S. Cl. 5/618; 5/720; 5/717

(57) ABSTRACT

An adjustable bed includes an articulated deck comprising head, seat, leg and foot deck boards hingedly joined together and supported from a frame located above a stationary base. A intermediate cushioning layer, including a pocketed coil spring assembly, is secured to the deck boards. A mattress or similar structure resides on top of the intermediate cushioning layer.

### FIELD OF THE INVENTION

This invention relates generally to adjustable beds and, more particularly, to an adjustable bed having an intermediate pocketed spring assembly.

### BACKGROUND OF THE INVENTION

A well known type of bedding product comprises a motorized adjustable bed in which an articulated frame supports a mattress. These motorized adjustable beds have traditionally been used in hospitals but more and more are being installed and used in residential homes. Motorized adjustable beds have conventionally had an upper body support movable between an inclined position in which it supports the patient in a sitting position and a prone position in which the patient lies down in a generally horizontal position. In addition, a leg support is movable between positions and may be adjusted to a desired degree of inclination. An actuating mechanism, commonly two or more electric motors, raises and lowers the head and leg supports of the articulated bed frame. U.S. Pat. No. 5,640,730 discloses such an adjustable bed.

U.S. Pat. Nos. 6,499,162 and 6,640,365 disclose adjustable beds comprising a plurality of bed plates pivotally secured together for supporting a mattress. Connecting elements or links pivotally connect a base to the bed plates. A movable member slides along the base and is activated by a piston movable from inside a cylinder secured to the base. Activation of a power source such as an electric motor causes movement of the bed plates via movement of the sliding member.

One desirable characteristic of adjustable beds is increased comfort or cushioning.

It is therefore been an objective of this invention to provide an adjustable bed with an additional cushioning layer. To that end, and in accordance with this invention, a pocketed spring assembly may be incorporated into an adjustable bed to provide increased cushioning to the adjustable bed. Such additional cushioning may improve the feel to the user of the adjustable bed while in bed whether the adjustable bed is fully inclined or horizontal.

### SUMMARY OF THE INVENTION

This invention comprises an adjustable bed having an adjustable deck for supporting a mattress. The adjustable bed is preferably powered by an electric motor driven linear actuator assembly. However, any other drive assembly, such as a conventional electrical motor driven screw and nut actuator system may be used in accordance with the present invention.

The adjustable bed, in one embodiment, comprises a stationary base comprising a pair of opposed side rails, a head end rail and a foot end rail located at the head and foot ends of the adjustable bed, respectively. Supports extending downwardly from the head and foot end rails support the base a fixed distance above the floor or supporting surface. Although legs are preferable, other types of supports may be used to raise and/or maintain the stationary base above the supporting surface.

Each of the side rails of the base has a channel built therein. More particularly, each of the side rails of the stationary base has a “C-shaped” cross-sectional configuration which defines the channel.

This adjustable bed further comprises a frame spaced above the stationary base and movable relative to the stationary base. Such an adjustable bed is known in the art as a “wall hugger” adjustable bed. The frame includes a pair of side assemblies joined by transversely extending cross members. Each of the side assemblies of the frame comprises a generally“L-shaped” member comprising a vertically oriented leg portion and a horizontally oriented side portion. A support leg is secured to the horizontally oriented side portion of the generally“L-shaped” member so each side assemblies has two legs. In combination, each side assembly of the movable frame has two legs, each having a roller rotatably secured to the leg at the bottom thereof which travels or moves in one of the channels of one of the side rails of the stationary base.

The adjustable bed further comprises an articulated deck. The articulated deck comprises a head deck board, a seat deck board fixedly secured to the movable frame, a leg deck board and a foot deck board hingedly joined to each other. The articulated deck is movable between a horizontal position in which all of the deck boards are horizontal and coplanar and a fully inclined position in which the head, leg and foot boards are inclined and the seat deck board remains in its horizontal position and fixed to the movable frame.

The adjustable bed further comprises a pair of foot links which connect the movable frame to the foot deck board. Each foot link has an adjustable length but may be manually set to have a predetermined, fixed length. Each foot link is pivotally secured to one of the side rails of the movable frame at one end and pivotally secured to a bracket fixedly secured to the foot deck board at its other end.

A linear actuator assembly is operatively coupled to the movable frame of the adjustable bed and moves with the frame. The linear actuator assembly functions to move the articulated deck between a first horizontal position in which all of the deck boards are co-planar in a horizontal position and a second fully inclined position in which the head deck board is inclined, the seat deck board generally horizontal, the leg and foot deck boards inclined.

The linear actuator assembly comprises at least one linear actuator. In one embodiment, two linear actuators are used, each one being secured at one end to one of the cross members of the frame and secured at the other end to link arms extending outwardly from a pivotal or rotatable torque tube. Such a drive mechanism is disclosed in pending U.S. patent application Ser. No. 11/870,148, which is fully incorporated herein. The first and second torque tubes are part of the movable frame, are pivotally secured to brackets secured to side assemblies of the movable frame and extend between the side assemblies of the frame.

A pair of operating arms are welded or otherwise secured to each torque tube, each of the operating arms having a roller at the end thereof for engaging the articulated deck. The operating arms welded or otherwise secured to the first torque tube have rollers at the ends thereof which contact the head deck board of the articulated deck and upon the first torque tube rotating or pivoting raise the head deck board from its first horizontal position to its second inclined position. Likewise, operating arms welded or otherwise secured to the second torque tube have rollers at the ends thereof which contact the leg deck board of the articulated deck and upon the second torque tube rotating or pivoting raise the leg deck board from its first horizontal position to its second inclined position.

In operation, starting from the first position of the adjustable bed in which the articulated deck is generally horizontal, an operator activates the motorized actuator assembly in any known manner. The electric motors or linear actuators rotate or pivot the torque tubes which, in turn, causes the operating arms extending outwardly from the torque tubes to rotate or pivot about a horizontal axis. Movement of the operating arms causes the rollers at the ends of the operating arms to contact the head and leg deck boards to move the head and leg deck boards from their first horizontal position to their second inclined position. As the head deck board inclines, the seat deck board moves horizontally towards the head end of the bed with the frame in what is known in the industry as a wall hugger motion. As the seat deck board moves towards the head end of the bed, the leg deck board moves from its first horizontal position to its second inclined position. This movement of the leg deck board causes the foot deck board to incline, its foot edge moving towards the head end of the bed as the foot links pivot about horizontal pivot axes.

The configuration of this embodiment of adjustable bed allows a user to move an upper frame of the adjustable bed relative to a stationary base using rollers traveling in channels in the base. The adjustable bed enables the deck to move between a first horizontal or prone position to a second inclined position with the assistance of the motorized actuator assembly of the articulated bed.

The adjustable bed further comprises a pocketed spring assembly secured to the articulated deck. The pocketed spring assembly comprises strings of pocketed springs joined together. The springs inside the pockets are usually coil springs but may be other shapes or configurations of springs.

In some embodiments, the adjustable bed has a longitudinal dimension or length and a transverse dimension or width, the longitudinal dimension being greater than the transverse dimension. The strings of springs may extend either longitudinally from head to foot or transversely from side to side.

Regardless of their orientation, the strings of springs of the pocketed spring assembly are secured to the articulated deck. The pocketed spring assembly or any portion of the assembly may be glued to the articulated deck or a portion thereof. Alternatively, the pocketed spring assembly may be stapled or secured in any other known manner to the upper surface of the articulated deck.

The adjustable bed further comprises an upper border secured to the upper surface of the articulated deck and extending around the perimeter of the articulated deck so as to surround the pocketed spring assembly above the articulated deck. The upper border may be foam, wood or any other suitable material.

The adjustable bed further comprises an lower border secured to the lower surface of the articulated deck and extending around the perimeter of the articulated deck so as to improve the appearance of the adjustable bed when an adjustable bed cover is put over the adjustable bed base. The lower border may be foam, wood or any other suitable material.

In alternative embodiments of adjustable beds, such as non wall hugger adjustable beds in which the upper carriage or frame remains fixed relative to a stationary base, a pocketed spring assembly may be incorporated into the adjustable bed base to provide additional cushioning.

These and other objects and advantages of the present invention will be more readily apparent from the following drawings.

### BRIEF DESCRIPTION OF THE DRAWINGS

FIG. 1 is a top perspective view of an adjustable bed made in accordance with this invention in a horizontal position supporting a mattress shown in phantom;

FIG. 1A is a top perspective view of an adjustable bed like the adjustable bed of FIG. 1 without the mattress showing the pocketed spring assembly having the strings of springs extending transversely;

FIG. 2 is a partially disassembled view of the adjustable bed of FIG. 1 without the mattress;

FIG. 2A is a side elevational view, partially cut away, of a string of springs used in the pocketed spring core of FIG. 1;

FIG. 3 is a bottom perspective view of the adjustable bed of FIG. 1 without the mattress in a fully inclined position;

FIG. 4 is a bottom perspective view of the adjustable bed of FIG. 1 without the mattress in a horizontal position;

FIG. 5 is a side elevational view of the adjustable bed of FIG. 1 without the mattress in a horizontal position;

FIG. 6 is a side elevational view of the adjustable bed of FIG. 1 without the mattress in a fully inclined position;

FIG. 7 is a bottom perspective view of an alternative embodiment of adjustable bed in a fully inclined position without the mattress; and

FIG. 8 is a side elevational view of the adjustable bed of FIG. 7 without the mattress in a horizontal position.

### DETAILED DESCRIPTION OF THE DRAWINGS

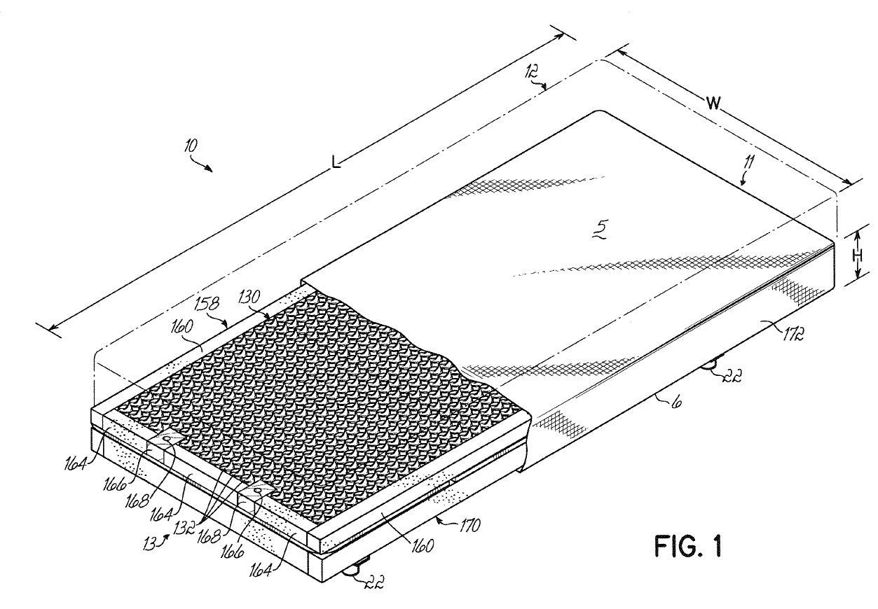

Referring to the drawings, and particularly to FIG. 1, there is illustrated an adjustable bed 10 supporting a mattress 1 2. The adjustable bed 10 may be used to support any type of mattress including an air mattress, a coil spring mattress or any other type of mattress. The mattress 12 does not form a part of the present invention and is shown only in FIG. 1 in phantom.

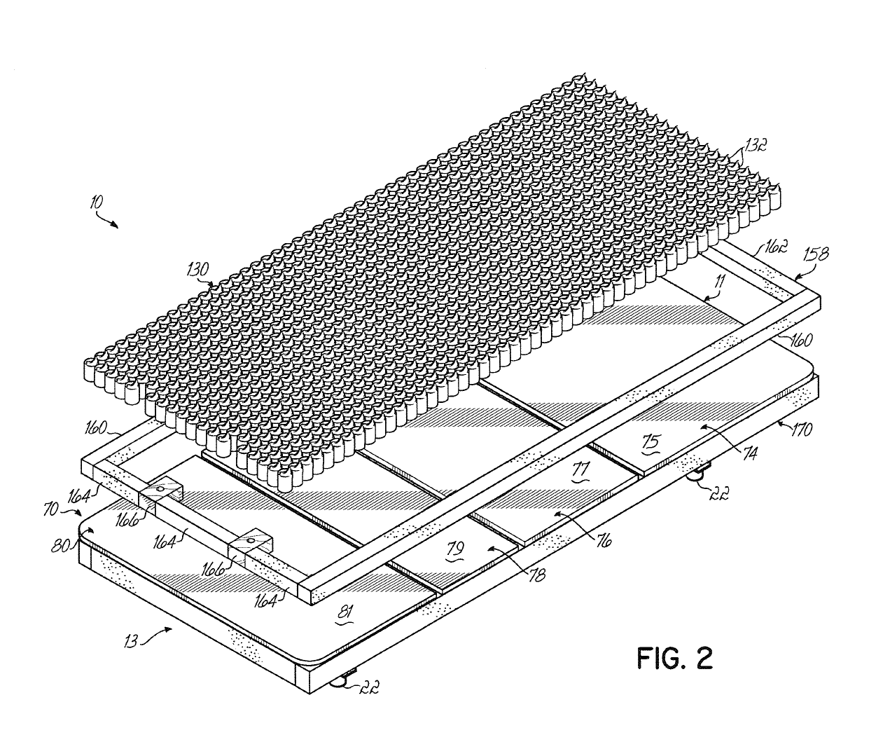

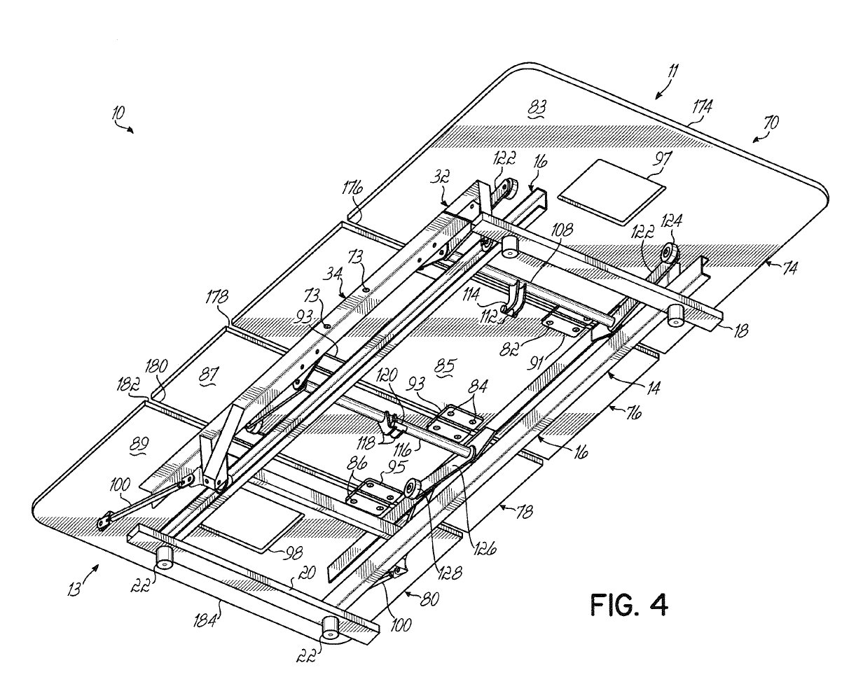

As shown in FIG. 1, the adjustable bed 10 has a longitudinal dimension or length L, a transverse dimension or width W and an upper surface 5 and a lower surface 6 defining a height H. The length L is commonly greater than the width W; however, the length L and width W may be the same dimensions. The adjustable bed 10 head end 11 and a foot end 13. The adjustable bed 10 is movable between a first horizontal position shown in FIGS. 1, 4 and 5 and a fully inclined position as shown in FIGS. 3 and 6. Typically, an operator or user sleeps with the adjustable bed 10 in its first horizontal position and reads or watches television with the adjustable bed in its fully inclined position. However, the adjustable bed 10 may assume any intermediate position between the extreme positions illustrated and maintained in such a position.

As shown in FIG. 3, the adjustable bed 10 comprises a stationary generally rectangular base 14 comprising a pair of opposed side rails 16, a head end rail 18, a foot end rail 20 and four legs 22 supporting the base 14 a fixed distance about a floor or supporting surface (not shown). The head and foot end rails 18, 20, respectively, each are secured to each side rail 16 and extend therebetween. The head and foot end rails 18, 20, respectively, are illustrated being rectangular in cross-section. However, they may be any desired size or shape, hollow or solid. The legs 22 are shown secured and extending downwardly from the head and foot end rails 18, 20, respectively, but may be secured to the side rails 16 if desired. Although a cylindrical shaped leg 22 is illustrated, any configuration or length of leg or similar support may be used.

As shown in FIG. 3, each of the side rails 16 of the base 14 has a generally C-shaped cross-sectional configuration including a vertically oriented side portion 24, a horizontally oriented top portion 26 extending outwardly from the upper edge of the side portion 24 and a horizontally oriented bottom portion 28 extending outwardly from the lower edge of the side portion 24. The side, top and bottom portions, 24, 26 and 28, respectively, define an outwardly facing channel 30 in each side rail 16 of the base 14. Although each side rail 16 is illustrated having a generally C-shaped cross-sectional configuration along its entire length, any desired configuration or length of side rail may be used in the base. For example, the channels may be shaped differently than those illustrated.

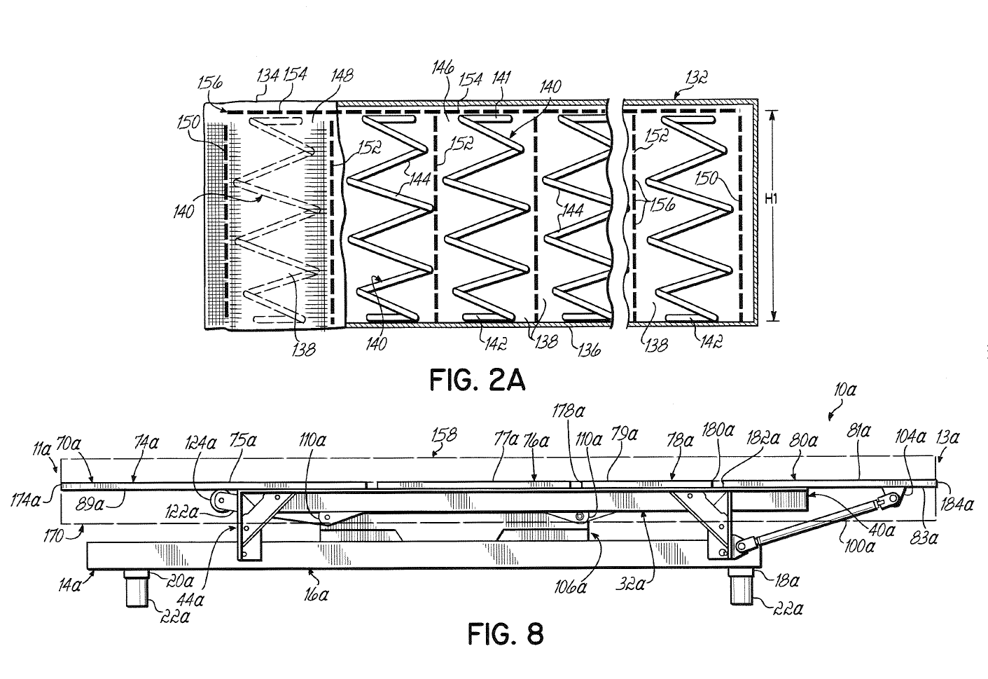

The adjustable bed 10 further comprises a frame 32 movable relative to the stationary base 14. The frame 32 is movable between a first position shown in FIGS. 1, 4 and 5 when the adjustable bed 10 is in its first horizontal position and a second position shown in FIGS. 3 and 6 when the adjustable bed 10 is in its fully inclined position. In its first position shown in FIGS. 1 and 4, the frame 32 is located proximate the foot end 13 of the bed 10 (to the right as shown in FIGS. 1, 4 and 5). In its second position shown in FIGS. 3 and 6, the frame 32 is located proximate the head end 11 of the bed (to the left as shown in FIG. 6).

As shown in FIG. 3, the movable frame 32 comprises a pair of side assemblies 34 connected by front and rear cross members 36, 38, respectively. Each of the front and rear cross members 36, 38, respectively, are joined to each side assembly 34 and extends therebetween. The front and rear cross members 36, 38, respectively, of the movable frame 32 are illustrated being rectangular in cross-section. However, they may be any desired size or shape, hollow or solid.

Each of the side assemblies 34 of the movable frame 32 comprises a generally “L-shaped” member 40 having a horizontal portion 42 and a vertical leg portion 44 at the head end 11 of the adjustable bed 10 extending downwardly from the horizontal portion 42 of the generally “L-shaped” member 40. The horizontal portion 42 has a vertical flange 46 and a horizontal flange 48 while the vertical leg portion 44 has a first flange 50, a continuation of the horizontal flange 48 and a second flange 52, a continuation of the vertical flange 46. Thus, each portion 42, 44 of each generally “L-shaped” member 40 has an “L-shaped” cross sectional configuration.

A front brace 54 extends between the horizontal portion 42 and the vertical leg portion 44 of the generally “L-shaped” member 40. The brace 54 is riveted, welded or otherwise secured to the vertical flange 46 of the horizontal portion 42 and the second flange 52 of the leg portion 44 of the generally “L-shaped” member 40. Although one configuration of front brace 54 is illustrated, other configurations or styles of braces may be used.

For purposes of this document, the vertical leg portion 44 of each generally “L-shaped” member 40 of the movable frame 32 may be referred to as a front leg 56 which has a front roller 58 rotatably secured at the bottom thereof, each front roller 58 being sized and adapted to travel inside the channel 30 of one of the side rails 16 of the stationary base 14. The front roller 58 is rotatably secured to the second flange 52 of the front leg 56.

Each of the side assemblies 34 further comprises a support or rear leg 60 having a first flange 62 and a second flange 64 at right angles or orthogonal to each other. Thus, the support or rear leg 60 has a cross sectional configuration which is generally “L-shaped.” The first flange 62 of the rear leg 60 is parallel the first flange 50 of the front leg 56 while the second flange 64 of the rear leg 60 is parallel the second flange 52 of the front leg 56. A rear roller 66 is rotatably secured to the second flange 64 of the rear leg 60 of each side assembly 34 of the movable frame 32. Each rear roller 66 is sized and adapted to travel inside the channel 30 of one of the side rails 16 of the stationary base 14.

A rear brace 68 extends between the horizontal portion 42 of the generally “L-shaped” member 40 and the rear leg 60. The rear brace 68 is riveted, welded or otherwise secured to the vertical flange 46 of the horizontal portion 42 of the generally “L-shaped” member 40 and the second flange 64 of the rear leg 60 of each side assembly 34. Although one configuration of rear brace 68 is illustrated, other braces may be used.

The articulated deck 70 comprises a head deck board 74, a seat deck board 76, a leg deck board 78 and a foot deck board 80. Each of the deck boards is preferably the same width but any two deck boards may be different widths, if desired. Deck boards 74, 76, 78 and 80 have upper surfaces 75, 77, 79 and 81, respectively, and lower surfaces 83, 85, 87 and 89, respectively. A portion of the articulated deck 70, the seat deck board 76, is operatively coupled to the movable frame 32 with fasteners 73.

As best illustrated in FIGS. 3 and 4, the head deck board 74 is hingedly secured to the seat deck board 76 with hinges 91 secured to the lower surfaces 83, 85 of the head and seat deck boards 74, 76, respectively, with fasteners 82. Similarly, seat deck board 76 is hingedly secured to leg deck board 78 with hinges 93 secured to the lower surfaces 85, 87 of the seat and leg deck boards 76, 78, respectively with fasteners 84. Leg deck board 78 is hingedly secured to foot deck board 80 with hinges 95 secured to the lower surfaces 87, 89 of the leg and foot deck boards 78, 80, respectively with fasteners 86. Although, two hinges are shown securing adjacent deck boards, any number of hinges may be used including one continuous hinge.

The deck boards 74, 76, 78 and 80 are preferably made of plywood, but may be made of plastic, oriented strand board or any other material.

As illustrated in FIG. 4, the head deck board 74 has a rectangular hole 97 therein which may be used to mount a massage unit (not shown) as is common in the industry. Similarly, as illustrated in FIGS. 3 and 4, the foot deck board 80 has a rectangular hole 98 therein which may be used to mount a massage unit (not shown) as is common in the industry and disclosed in U.S. Pat. Nos. 7,039,970 and 7,322,058, which are both fully incorporated herein. If desired, one or both of these holes 97, 98 may be omitted.

As illustrated in FIGS. 3 and 4, the seat deck board 76 is fixedly secured to the movable frame 32 with fasteners 73. More particularly, the fasteners 73 pass through holes in the horizontal flange 48 of the horizontal portion 42 of each side assembly 34 of the movable frame 32 and into the material of the seat deck board 76. Thus, the seat deck board 76 remains flat and fixed in the same location relative to the movable frame 32. When the movable frame 32 moves, the seat deck board 76 moves with it.

The adjustable bed 10 further comprises two foot links 100 or connectors, each of which may be adjusted to the same fixed length. Each of the foot links 100 is pivotally secured at a lower end to one of the rear legs 60 of one of the side assemblies 34 of the movable frame 32 with fastener 102 so that each pivots about a horizontal pivot axis. See FIG. 3.

Each foot link 100 is pivotally secured at its upper end to a bracket 104 fixed to the lower surface 89 of the foot deck board 80. The articulated deck 70 is moved by a motorized linear actuator assembly 106 between a first position shown in FIGS. 1, 4 and 5 in which the deck boards 74, 76, 78 and 80 are generally co-planar in a horizontal position or orientation and a second position shown in FIGS. 3 and 6. In the second position, the head deck board 74 is inclined, the seat deck board 76 is substantially horizontal and fixed to the movable frame 32, the leg and foot deck boards 78, 80 inclined.

The motorized linear actuator assembly 106 is attached to the movable frame 32 and moves with the movable frame 32 relative to the stationary base 14. The motorized linear actuator assembly 106 comprises a pair of linear actuators each driven by a motor. One of the linear actuators of motorized linear actuator assembly 106 is adapted to pivot or rotate a first torque tube 108 which comprises part of the movable frame 32 and extends between brackets 110 fixedly secured to the side assemblies 34 of the movable frame 32. Each bracket 110 is fixed to the vertical flange 46 of the horizontal portion 42 of the side assembly 34. See FIG. 3.

The motorized linear actuator assembly 106 further comprises a pair of linear actuators, one of which is receivable engages a pin 112 extending between a pair of spaced link arms 114 (see FIG. 4). Each link arm 114 is welded or secured at its upper end to first rotatable or pivotal torque tube 108. The other linear actuator receivable engages a pin 120 extending between a pair of spaced link arms 11 (see FIG. 4).

As shown in FIGS. 3 and 4, the second pivotal or rotatable torque tube 16 comprises part of the movable frame 32 and extends between brackets 110 fixedly secured to the side assemblies 34 of the movable frame 32 and more particularly to the vertical flange 46 of the horizontal portion 42 of the side assembly 34. As shown in FIGS. 3 and 4, a pair of spaced link arms 118 are welded or secured at their upper ends to second rotatable or pivotal torque tube 116. A pin 120 extends between link arms 118. The second linear actuator of motorized linear actuator assembly 106 engages the pin 120 and upon actuation or extension rotates the second torque tube 116. The first and second torque tubes 108, 116 comprise part of the movable frame 32, move with the movable frame 32 and are pivoted or rotated by the motorized linear actuator assembly 106 which engages part of the movable frame 32 and moves with it.

As best shown in FIG. 6, the first torque tube 108 has a pair of spaced operating arms 122 extending upwardly therefrom, each arm 122 being a fixed length and having a roller 124 at the end thereof for engaging the lower surface 83 of the head deck board 74. Each operating arm 122 is welded or otherwise fixedly secured to the first torque tube 108 at its lower end.

Likewise, the second torque tube 116 has a pair of spaced operating arms 126 extending upwardly therefrom, each arm 126 being a fixed length and having a roller 128 at the end thereof for engaging the lower surface 87 of the leg deck board 78. See FIG. 6. Each operating arm 126 is welded or otherwise fixedly secured to the second torque tube 116 at its lower end.

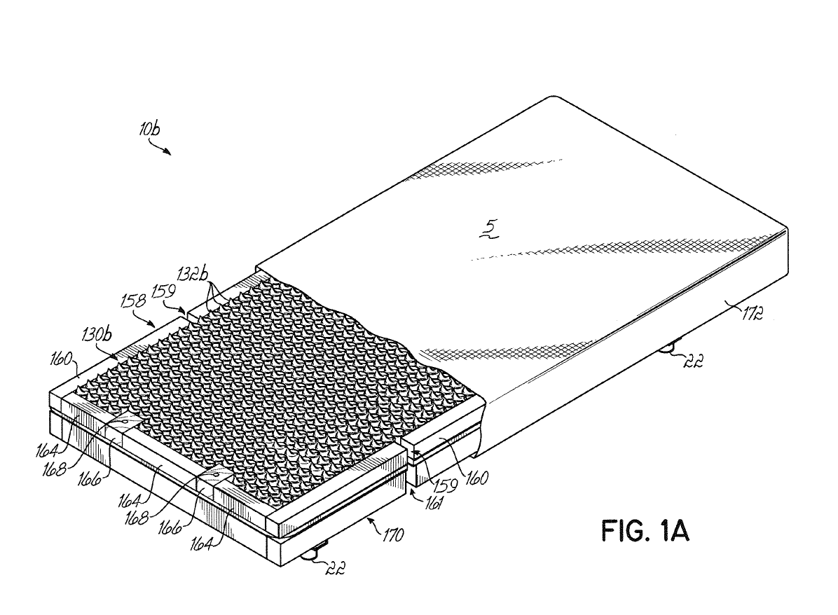

As best illustrated in FIG. 2, the adjustable bed 10 further comprises a pocketed spring assembly 130 for supporting the mattress 12 and providing an additional cushioning layer to the finished product. The pocketed spring assembly 130 includes a plurality of longitudinally extending strings of springs 132 joined together as shown in FIG. 2. Adjacent strings of springs are preferably glued together but be joined to each other using any known technology such as ultrasonic welding.

FIG. 2A illustrates a string of springs 132 having an upper surface 134 and a bottom or lower surface 136, the distance between which defines the height H1 of the string of springs 132. Each string of springs 132 comprises a row of interconnected fabric pockets 138, each fabric pocket containing a coil spring 140. As shown in FIG. 2A, each coil spring 140 has an upper end turn 141, a lower end turn 142 and a plurality of central convolutions 144 between the end turns 141, 142. Although one configuration of coil spring is shown, any other spring whether a coil spring or not may be used with the present invention.

Preferably, only one piece of fabric is used to form a string of springs 132, the piece of fabric being folded over onto itself around the coil springs 140 to create a first ply 146 and a second ply 148. As illustrated in FIG. 2A, the first ply 146 is behind the second ply 148. As is known in the art, opposite sides or plies of the fabric are sewn, welded or otherwise secured together to create a pair of outermost seams 150, a plurality of parallel internal seams 152, and a longitudinal top seam 154. Although seams 150, 152 and 154 are illustrated as a plurality of spaced, linear segments 156, they may comprise continuous lines or a series of dots or other arrangement without departing from the spirit of this document.

In one embodiment, the height H1 of the strings of springs 132 is approximately one inch. Therefore, the height of the pocketed spring assembly 130 is approximately one inch. However, the strings of springs and pocketed spring assembly may be any desired height. Heights which have proven satisfactory are between one and four inches.

As best illustrated in FIG. 2, the adjustable bed 10 further comprises an upper border 158 generally rectangular in shape and secured to the upper surface of the articulated deck 70. More particularly, the upper border 158 comprises two or more opposed side pieces 160, a head end piece 162 and three foot end pieces 164 separated from each other by two anchors 166. Each piece of the upper border 158 is secured to an upper surface of at least one of the deck boards. The pieces of the upper border 158 are preferably made of foam, either polyethylene or polyurethane, but may be made of wood or any other suitable material. If made of a non-flexible material such as wood, for example, the upper border may be made of additional segments joined together to allow the border to flex when the deck 70 is inclined as shown in FIGS. 3 and 6. In such a situation, the upper and lower borders may be made from any number of pieces of material with joints 159, 161 between pieces of the upper and lower borders, respectively, as shown in FIG. 1A. Each anchor 166 has a hole 168 therein to receive a mattress stop (not shown) as known in the art. The upper border 158 surrounds the pocketed spring assembly 130 and provides a border support to the adjustable bed 10.

As best illustrated in FIG. 2, the adjustable bed 10 further comprises an lower border 1 70 generally rectangular in shape and secured to the lower surface of the articulated deck 70. This lower border 1 70 may comprise one piece or multiple pieces of foam or wood or any other suitable material. One purpose of the lower border 170 is to provide an attractive appearance when an upholstered covering 172 as shown in FIG. 1 is put over the adjustable bed 10.

In operation, starting from the first position of the adjustable bed 10 shown in FIGS. 1, 4 and 5 in which the articulated deck 70 is generally horizontal, an operator (not shown) activates the motorized linear actuator assembly 106 with or without a remote (not shown). Activation of the motorized linear actuator assembly 106 rotates or pivots torque tubes 108, 116. Rotation or pivoting the torque tubes 108, 116 causes the operating arms 122, 126 to rotate or pivot about a horizontal axis parallel the torque tubes 108, 116. The rollers 124, 128 located at the upper ends of the operating arms 122, 126 contact the head and leg deck boards 74, 78, respectively, and move them from their first horizontal position shown in FIGS. 1, 4 and 5 to their second fully inclined position shown in FIGS. 3 and 6 in which the front edge 174 of the head deck board 74 is above the rear edge 176 of the head deck board 74.

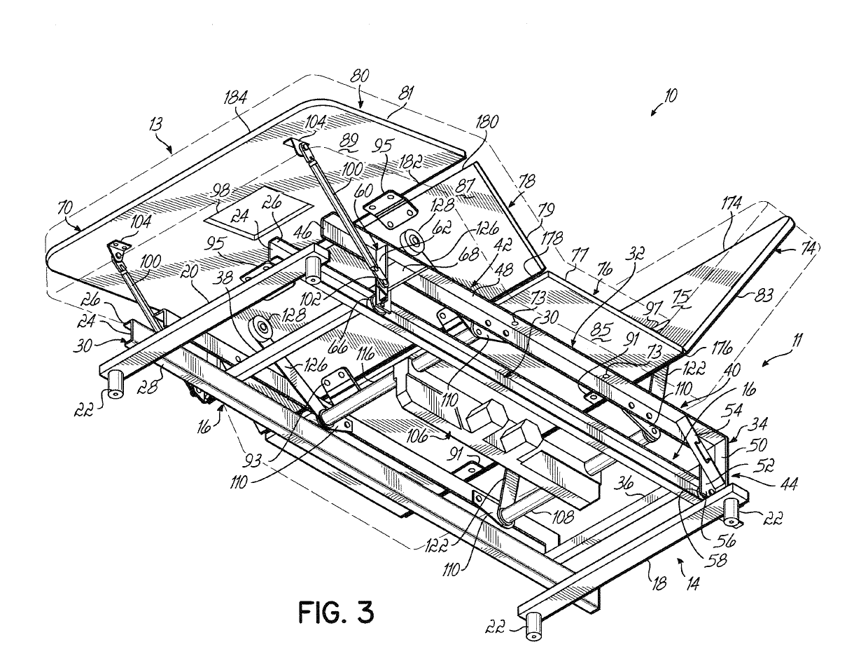

As the head deck board 74 inclines, the seat deck board 76 and movable frame 32 move towards the head end 11 of the bed (to the left in FIGS. 4 and 6), causing or pulling the leg deck board 78 horizontally towards the head end 11 of the bed. The leg deck board 78 also moves towards the head end 11 of the bed 10, from its first horizontal position shown in FIGS. 1, 4 and 5 to its second fully inclined position shown in FIGS. 3 and 6. In this fully inclined position, the front edge 178 of the leg deck board 78 is lower than the rear edge 180 of the leg deck board 78. This movement of the leg deck board 78 causes or pulls the foot deck board 80 towards the head end 11 of the bed as the foot links 100 are pivoted about horizontal pivot axes in a counterclock wise direction as viewed in FIGS. 5 and 6. In its fully inclined position shown in FIG. 6, the front edge 182 of the foot deck board 80 is higher than the rear edge 184 of the foot deck board 80.

As desired, the adjustable bed 10 may be moved from its fully inclined position shown in FIG. 6 (in which the front edge 174 of the head deck board 74 is above the rear edge 176 of the head deck board 74) back to its horizontal position shown in FIG. 5 via use of the motorized linear actuator assembly 106.

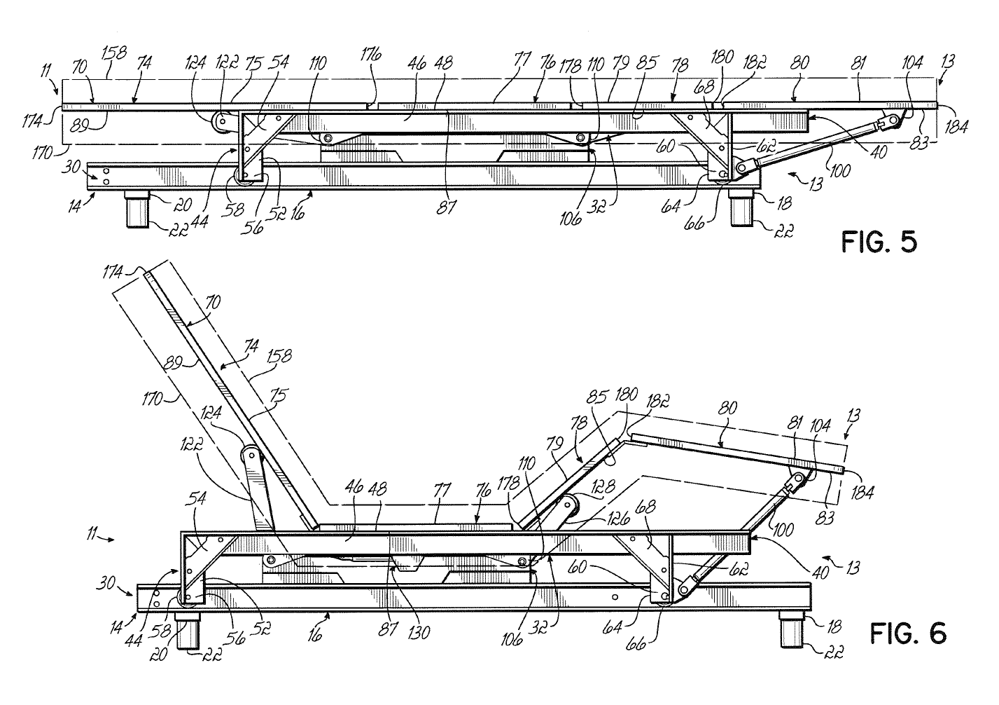

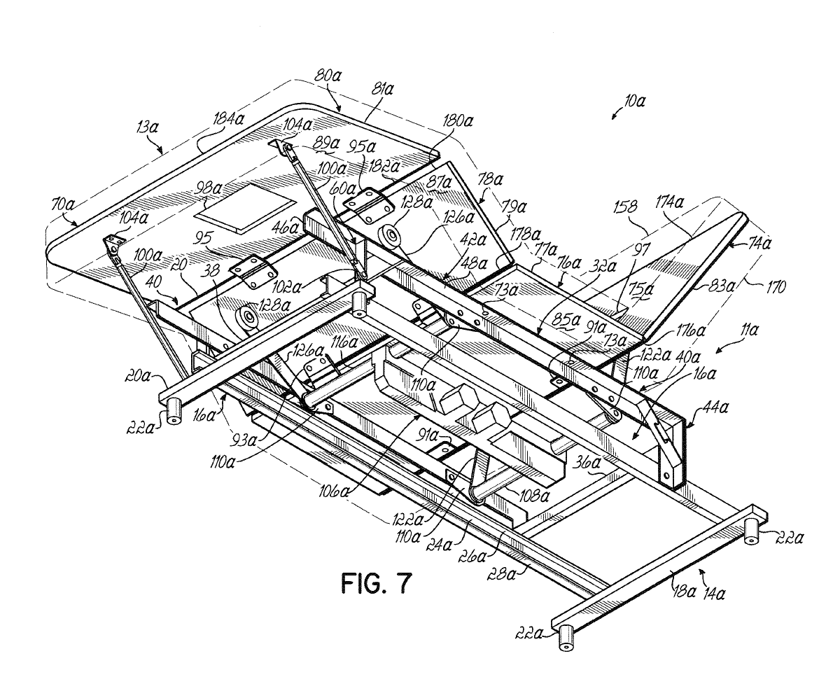

The pocketed spring assembly 130 may be used with any adjustable bed. FIGS. 7 and 8 illustrate an alternative embodiment of adjustable bed 10a having the pocketed spring assembly 130. This adjustable bed 10a is not considered a wall hugger adjustable bed because the frame does not move relative to the base. For purposes of simplicity, like parts are identified with like numbers but an “a” designation in the description of this embodiment. The adjustable bed 10a has a head end 11a and a foot end 13a. The adjustable bed 10a is movable between a first horizontal position shown in FIG. 8 and a fully inclined position shown in FIG. 7. This adjustable bed 10a is equipped with a pocketed spring assembly 130 as described above and illustrated in FIGS. 1-6.

The adjustable bed 10a comprises a stationary generally rectangular base 14a, like base 14, comprising a pair of opposed side rails 16a, a head end rail 18a, a foot end rail 20a and four legs 22a supporting the base 14a a fixed distance about a floor or supporting surface (not shown). The head and foot end rails 18a, 20a, respectively, each are secured to each side rail 16a and extend therebetween. The head and foot end rails 18a, 20a, respectively, are illustrated being rectangular in cross-section. However, they may be any desired size or shape, hollow or solid. The legs 22a are shown secured and extending downwardly from the head and foot end rails 18a, 20a, respectively, but may be secured to the side rails 16a. Although a cylindrical shaped leg 22a is illustrated, any configuration or length of leg or similar support may be used.

As shown in FIG. 7, each of the side rails 16a of the base 14a has a generally C-shaped cross-sectional configuration including a vertically oriented side portion 24a, a horizontally oriented top portion 26a extending outwardly from the upper edge of the side portion 24a and a horizontally oriented bottom portion 28a extending outwardly from the lower edge of the side portion 24a. The side, top and bottom portions, 24a, 26a and 28a, respectively, define an inwardly facing channel 30a in each side rail 16a (opposite the direction of the channels 30). Although each side rail 16a is illustrated having a generally C-shaped cross-sectional configuration along its entire length, any desired configuration or length of side rail may be used in the base. For example, the channels may be shaped differently than those illustrated.

The adjustable bed 10a further comprises an upper carriage or frame 32a welded or otherwise fixed relative to the stationary base 14a. The frame 32a comprises a pair of side assemblies 34a identical to the side assemblies 34 of frame 32 described above.

An articulated deck 70a is operatively coupled to the frame 32a; more particularly seat deck board 76a of the articulated deck 70a is operatively coupled to the frame 32a with fasteners 73a. The articulated deck 70a comprises a head deck board 74a, a seat deck board 76a, a leg deck board 78a and a foot deck board 80a. Each of the deck boards is preferably the same width but any two deck boards may be different widths, if desired. Deck boards 74a, 76a, 78a and 80a have upper surfaces 75a, 77a, 79a and 81a, respectively, and lower surfaces 83a, 85a, 87a and 89a, respectively.

As illustrated in FIG. 7, the head deck board 74a is hingedly secured to the seat deck board 76a with hinges 91a as described above with respect to hinges 91. Similarly, seat deck board 76a is hingedly secured to leg deck board 78a with hinges 93a as described above with respect to hinges 93. Leg deck board 78a is hingedly secured to foot deck board 80a with hinges 95a as described above with respect to hinges 95. Although, two hinges are shown in FIG. 7 securing adjacent deck boards, any number of hinges may be used including one continuous hinge. The deck boards 74a, 76a, 78a and 80a are preferably made of plywood, but may be made of plastic, oriented strand board or any other material.

As illustrated in FIG. 7, the head deck board 74a may have a rectangular hole 97a therein which may be used to mount a massage unit (not shown) as is common in the industry. Similarly, as illustrated in FIG. 7, the foot deck board 80a may have a rectangular hole 98a therein which may be used to mount a massage unit (not shown) as is common in the industry.

As illustrated in FIG. 7, the seat deck board 76a is fixedly secured to the frame 32a with fasteners 73a. Thus, the seat deck board 76a remains flat and fixed in the same location relative to the frame 32a.

The adjustable bed 10a further comprises two foot links 100a or connectors, each adjusted to the same fixed length, each pivotally secured at a lower end to one of the rear legs 60a of the side assemblies 34a of the frame 32a so that each pivots about a horizontal pivot axis. See FIG. 7. Each foot link 100a is pivotally secured at its upper end to a bracket 104a fixed to the lower surface 89a of the foot deck board 80a.

The articulated deck 70a is moved by a motorized linear actuator assembly 106 between a first position shown in FIG. 8 in which the deck boards 74a, 76a, 78a and 80a are generally co-planar in a horizontal position or orientation and a second position shown in FIG. 7. In the second position, the head deck board 74a is inclined, the seat deck board 76a is substantially horizontal and fixed to the frame 32a, the leg deck board 78a inclined and the foot deck board 80a slightly inclined as shown in FIG. 7.

The motorized linear actuator assembly 106a is secured to the movable frame 32. The motorized linear actuator assembly 106a is identical to motorized linear actuator assembly 106 described above.

A first pivotal or rotatable torque tube 108a and a second pivotal or rotatable torque tube 116 comprise part of the frame 32 and each extends between brackets 110 fixedly secured to the side assemblies 34 of the movable frame 32. The first and second torque tubes 108a, 116a are pivoted or rotated by the motorized linear actuator assembly 106a which also comprises part of the frame 32a.

As best shown in FIG. 7, the first torque tube 108a has a pair of spaced operating arms 122a extending upwardly therefrom, each arm 122a being a fixed length and having a roller 124a at the end thereof for engaging the lower surface 83a of the head deck board 74a. Each operating arm 122a is welded or otherwise fixedly secured to the first torque tube 108a at its lower end.

Likewise, the second torque tube 116a has a pair of spaced operating arms 126a extending upwardly therefrom, each arm 126a being a fixed length and having a roller 128a at the end thereof for engaging the lower surface 87a of the leg deck board 78a. See FIG. 7. Each operating arm 126a is welded or otherwise fixedly secured to the second torque tube 116a at its lower end.

In operation, starting from the first position of the adjustable bed 10a shown in FIG. 8 in which the articulated deck 70a is generally horizontal, an operator (not shown) activates the motorized linear actuator assembly 106a with or without a remote (not shown). Activation of the motorized linear actuator assembly 106a rotates or pivots torque tubes 108a, 116a. Rotation or pivoting the torque tubes 108a, 116a causes the operating arms 122a, 126a to rotate or pivot about a horizontal axis parallel the torque tubes 108a, 116a. The rollers 124a, 128a located at the upper ends of the operating arms 122a, 126a contact the head and leg deck boards 74a, 78a, respectively, and move them from their first horizontal position shown in FIG. 8 to their second fully inclined position shown in FIG. 7 in which the head edge 174a of the head deck board 74a is above the rear edge 176a of the head deck board 74a.

As the head deck board 74a inclines, the seat deck board 76a and movable frame 32a remain stationary. The leg deck board 78a also moves from its first horizontal position shown in FIG. 8 to its second fully inclined position shown in FIG. 7. In this fully inclined position, the front edge 178a of the leg deck board 78a is lower than the rear edge 180a of the leg deck board 78a. This movement of the leg deck board 78a causes or pulls the foot deck board 80a towards the head end 11a of the bed 10a as the foot links 100a are pivoted about horizontal pivot axes in a clockwise direction as viewed in FIG. 7. In its fully inclined position shown in FIG. 7, the front edge 182a of the foot deck board 80 is higher than the rear edge 184a of the foot deck board 80a.

As desired, the adjustable bed 10a may be moved from its fully inclined position shown in FIG. 7 (in which the front edge 154a of the head deck board 74a is above the rear edge 155a of the head deck board 74a) back to its horizontal position shown in FIG. 8 via use of the motorized linear actuator assembly 106a.

FIG. 1A illustrates an alternative embodiment of the present invention comprising an adjustable bed 10b. The adjustable bed 10b is just like the adjustable bed 10 shown in FIG. 1 and described herein. However, the adjustable bed 10b has a pocketed spring assembly 130b having transversely extending strings of springs 132b instead of longitudinally extending strings of springs like those shown in FIG. 2. The pocketed spring assembly 130b may be secured to one or more of the deck boards of the adjustable bed 10b. In accordance with the present invention, any adjustable bed such as the one shown in FIGS. 7 and 8 may have a pocketed spring assembly with transversely, rather than longitudinally extending strings of springs.

Although we have described several embodiments of the invention, we do not intend to be limited except by the scope of the following claims. For example, the pocketed spring assembly may comprise pocketed springs joined in any desired manner; there need not be strings of pocketed springs joined together.

We claim:

1. An adjustable bed for supporting a mattress, said adjustable bed comprising:
a stationary base having a pair of opposed side rails, each of said side rails including a channel;
a frame movable relative to said stationary base, said frame including a pair of side assemblies;
rollers rotatably mounted to said side assemblies of said frame and being rotatable in said channels of said side rails of said base;
an articulated deck including a seat deck board secured to said movable frame, a head deck board hingedly secured to said seat deck board, a leg deck board hingedly secured to said seat deck board and a foot deck board hingedly secured to said leg deck board;
first and second pivotal torque tubes, each of said torque tubes extending between said side assemblies of said frame and being pivotally secured to brackets secured to side assemblies of said frame;
a pair of foot links, each of said foot links being pivotally secured to said frame at one end and being pivotally secured to brackets secured to said foot deck board at the other end;
at least one actuator for pivoting said torque tubes, said first torque tube being operatively coupled to a pair of operating arms having rollers at the ends therefor for engaging said head deck board to raise the head board and said second torque tube being operatively coupled to a pair of operating arms having rollers at the ends therefor for engaging said leg deck board to raise the leg deck board; and
an intermediate cushioning layer comprising a pocketed spring assembly secured to said articulated deck for supporting a mattress above the intermediate cushioning layer.

2. The adjustable bed of claim 1 wherein said pocketed spring assembly comprises strings of pocketed springs joined together.

3. The adjustable bed of claim 1 wherein said strings of pocketed springs extend longitudinally.

4. The adjustable bed of claim 1 wherein said strings of pocketed springs extend transversely.

5. The adjustable bed of claim 1 wherein said pocketed spring assembly is glued to said articulated deck.

6. The adjustable bed of claim 1 further comprising an upper border around said pocketed spring assembly above said articulated deck.

7. The adjustable bed of claim 1 further comprising a lower border secured to said articulated deck below said articulated deck.

8. An adjustable bed for supporting a mattress, said adjustable bed comprising:
a stationary base having a pair of opposed side rails;
a frame movable relative to said stationary base, said frame including a pair of side assemblies;
rollers rotatably mounted to said side assemblies of said frame and being rotatable on said side rails of said base;
an articulated deck comprising a seat deck board secured to said frame;
a head deck board hingedly secured to said seat deck board;
a leg deck board hingedly secured to said seat deck board;
a foot deck board hingedly secured to said leg deck board; and
a linear actuator assembly for moving said head, leg and foot deck boards between a horizontal position and an inclined position and moving said frame relative to said stationary base; and
an intermediate cushioning layer comprising a pocketed spring assembly secured to an upper surface of at least one of said deck boards for supporting a mattress above the intermediate cushioning layer.

9. The adjustable bed of claim 8 wherein said pocketed spring assembly comprises strings of pocketed springs joined together.

10. The adjustable bed of claim 8 wherein said strings of pocketed springs extend longitudinally.

11. The adjustable bed of claim 8 wherein said strings of pocketed springs extend transversely.

12. The adjustable bed of claim 8 wherein said pocketed spring assembly is glued to at least one of said deck boards.

13. The adjustable bed of claim 8 wherein said pocketed spring assembly is secured to all of said deck boards.

14. The adjustable bed of claim 8 wherein said pocketed spring assembly is glued to all of said deck boards.

15. The adjustable bed of claim 8 further comprising an upper foam border around said pocketed spring assembly above said articulated deck.

16. The adjustable bed of claim 15 further comprising a lower foam border secured to said articulated deck below said articulated deck.

17. An adjustable bed for supporting a mattress, said adjustable bed comprising:
a stationary base having a pair of opposed side rails, each of said side rails including a channel;
a frame secured to said stationary base, said frame including a pair of side assemblies;
an articulated deck including a seat deck board secured to said frame, a head deck board hingedly secured to said seat deck board, a leg deck board hingedly secured to said seat deck board and a foot deck board hingedly secured to said leg deck board;
first and second pivotal torque tubes, each of said torque tubes extending between said side assemblies of said frame;
at least one actuator for pivoting said torque tubes, said first torque tube being operatively coupled to a pair of operating arms having rollers at the ends therefor for engaging said head deck board to raise the head board and said second torque tube being operatively coupled to a pair of operating arms having rollers at the ends therefor for engaging said leg deck board to raise the leg deck board; and
an intermediate cushioning layer above said articulated deck comprising a pocketed spring assembly secured to an upper surface of at least one of said deck boards and an upper border around said pocketed spring assembly for supporting a mattress above the intermediate cushioning layer.

18. The adjustable bed of claim 17 further comprising a pair of foot links, each of said foot links being pivotally secured to said frame at one end and being pivotally secured to brackets secured to said foot deck board at the other end.

19. The adjustable bed of claim 17 wherein said pocketed spring assembly comprises strings of pocketed springs joined together.

20. The adjustable bed of claim 17 wherein said strings of pocketed springs extend longitudinally.

21. The adjustable bed of claim 17 wherein said strings of pocketed springs extend transversely.

22. The adjustable bed of claim 17 wherein the upper border around said pocketed spring assembly above said articulated deck is foam.

23. The adjustable bed of claim 17 further comprising a lower border secured to said articulated deck below said articulated deck.

24. An adjustable bed for supporting a mattress, said adjustable bed comprising:
a stationary base;
a frame secured to said stationary base, said frame including a pair of side assemblies;
an articulated deck including a seat deck board secured to said frame, a head deck board hingedly secured to said seat deck board, a leg deck board hingedly secured to said seat deck board and a foot deck board hingedly secured to said leg deck board; and
an intermediate cushioning layer comprising a pocketed spring assembly secured to an upper surface of said articulated deck and an upper border around said pocketed spring assembly for supporting a mattress above the intermediate cushioning layer.

25. The adjustable bed of claim 24 further comprising first and second pivotal torque tubes, each of said torque tubes extending between said side assemblies of said frame; and
at least one actuator for pivoting said torque tubes, said first torque tube being operatively coupled to a pair of operating arms having rollers at the ends therefor for engaging said head deck board to raise the head board and said second torque tube being operatively coupled to a pair of operating arms having rollers at the ends therefor for engaging said leg deck board to raise the leg deck board.

26. The adjustable bed of claim 24 wherein the upper border around said pocketed spring assembly above said articulated deck is foam.

27. The adjustable bed of claim 26 further comprising a lower border secured to said articulated deck below said articulated deck.
